(19) United States
(12) Patent Application Publication
(10) Pub. No.: US 2023/0037935 A1
(43) Pub. Date: Feb. 9, 2023

(54) METHODS AND DEVICES FOR ELECTRONIC COMMUNICATION ENHANCED WITH METADATA

(71) Applicant: MYANT INC., Toronto (CA)

(72) Inventors: Tony CHAHINE, Toronto (CA); Milad ALIZADEH-MEGHRAZI, Toronto (CA); Sherryl Lee Lorraine SCOTT, Toronto (CA)

(21) Appl. No.: 17/790,946

(22) PCT Filed: Dec. 17, 2020
(86) PCT No.: PCT/CA2020/051737

§ 371 Date: Jul. 5, 2022

Related U.S. Application Data
(60) Provisional application No. 62/957,609, filed on Jan. 6, 2020.

(51) Int. Cl. G06F 16/2457; G06F 16/23

(52) U.S. Cl. CPC G06F 16/24573; G06F 16/2358

(57) ABSTRACT

There are disclosed devices, methods, and systems for electronic communication enhanced with visual indicators of metadata. Metadata is received from a plurality of disparate sources, the metadata reflective of at least one of location, social connectedness, biomechanics, mood, and health and wellness states of an individual with whom a user is engaging in electronic communication. A visual representation of the metadata is generated, the visual representation including a plurality of visual indicators of the states. A user interface for electronic communication with the individual is presented, the user interface including the visual representation of the metadata. While the user is engaging in electronic communication with the individual, updated metadata from at least one of the disparate sources is received, and the user interface is updated to reflect the updated metadata.

### CROSS-REFERENCE TO RELATED APPLICATIONS

This application claims all benefit including priority to U.S. Provisional Patent Application 62/957,609, filed Jan. 6, 2020, and entitled “METHODS AND DEVICES FOR ELECTRONIC COMMUNICATION ENHANCED WITH METADATA”; the entire contents of which are hereby incorporated by reference herein.

### FIELD

This disclosure relates to electronic communication, and more particularly relates to electronic communication enhanced with metadata.

### BACKGROUND

The use of electronic communication has become commonplace with the proliferation of communication networks such as the Internet, General Packet Radio Services (GPRS), LTE, and the like. Electronic communication such as electronic mail, short message service (SMS), instant messaging, social media messaging, audio conferences, video conferences, and the like, allow users to engage in near instant communication with others around the globe. This is especially important as we are communicating with one another more and more at a distance. For example, it has become more commonplace for people to be working at a distance (e.g., remote office workers) or living remotely from one another (e.g., some family members living in rural locations and other family members living in urban locations, or friends and family living in different cities, countries, etc.).

However, electronic communication fails to convey certain information that would be exchanged as part of in-person communication including, for example, non-verbal cues. Accordingly, electronic communication may be less informative or less intimate than in-person communication.

### SUMMARY

In accordance with an aspect, there is provided a computing device for electronic communication enhanced with visual indicators of metadata. The device includes a display interface; at least one communication interface; at least one memory storing processor-executable instructions; and at least one processor in communication with the at least one memory. The at least one processor is configured to execute the instructions to: receive, by way of the at least one communication interface, metadata from a plurality of disparate sources, the metadata reflective of at least one of location, social connectedness, biomechanics, mood, and health and wellness states of an individual with whom a user of the computing device is engaging in electronic communication; generate a visual representation of the metadata, the visual representation including a plurality of visual indicators of the states; present, by way of the display interface, a user interface for electronic communication with the individual, the user interface including the visual representation of the metadata; receive, by way of the at least one communication interface, updated metadata, from at least one of the disparate sources; and update the user interface to reflect the updated metadata.

In accordance with another aspect, there is provided a computer-implemented method for electronic communication enhanced with visual indicators of metadata. The method includes, at an electronic device, receiving metadata from a plurality of disparate sources, the metadata reflective of at least one of location, social connectedness, biomechanics, mood, and health and wellness states of an individual with whom a user of the computing device is engaging in electronic communication; generating a visual representation of the metadata, the visual representation including a plurality of visual indicators of the states; presenting a user interface for electronic communication with the individual, the user interface including the visual representation of the metadata; and while the user is engaging in electronic communication with the individual, receiving updated metadata from at least one of the disparate sources; and updating the user interface to reflect the updated metadata.

In accordance with yet another aspect, there is provided a non-transitory computer-readable medium having stored thereon machine interpretable instructions which, when executed by a processor, cause the processor to perform a computer-implemented method as noted above.

Many further features and combinations thereof concerning embodiments described herein will appear to those skilled in the art following a reading of the instant disclosure.

### BRIEF DESCRIPTION OF DRAWINGS

In the figures,

FIG. 1 is a network diagram of users engaging in electronic communication by way of computing devices, in accordance with an embodiment;

FIG. 2 is a schematic diagram of an enhanced communication application executing, in accordance with an embodiment;

FIG. 3 shows an example screen of a user interface of the enhanced communication application of FIG. 2 when used for chat communication, in accordance with an embodiment;

FIG. 4 shows another example screen of a user interface of the enhanced communication application of FIG. 2, in accordance with an embodiment;

FIGS. 5A and 5B each shows a respective example screen portion of a user interface of the enhanced communication application of FIG. 2, in accordance with an embodiment;

FIG. 6A shows another example screen of a user interface of the enhanced communication application of FIG. 2, in accordance with an embodiment;

FIG. 6B shows a visual representation of metadata, in accordance with an embodiment;

FIG. 6C shows the example screen of FIG. 6A, reconfigured to show further metadata details, in accordance with an embodiment;

FIGS. 7A, 7B, 7C, and 7D each shows a respective example screen portion of a user interface displaying information regarding one type of metadata;

FIG. 8A shows an example screen portion of a user interface of the enhanced communication application of FIG. 2 for configuration thereof, in accordance with an embodiment;

FIG. 8B shows another example screen of a user interface of the enhanced communication application of FIG. 2, in accordance with an embodiment;

FIG. 9 shows an example screen of a user interface of the enhanced communication application of FIG. 2 when used for video communication, in accordance with an embodiment;

FIG. 10 is a flowchart showing example operation of the enhanced communication application of FIG. 2, in accordance with an embodiment;

FIG. 11 is a schematic diagram of a smart garment, in accordance with an embodiment; and

FIG. 12 is a schematic diagram of a computing device, in accordance with an embodiment.

### DETAILED DESCRIPTION

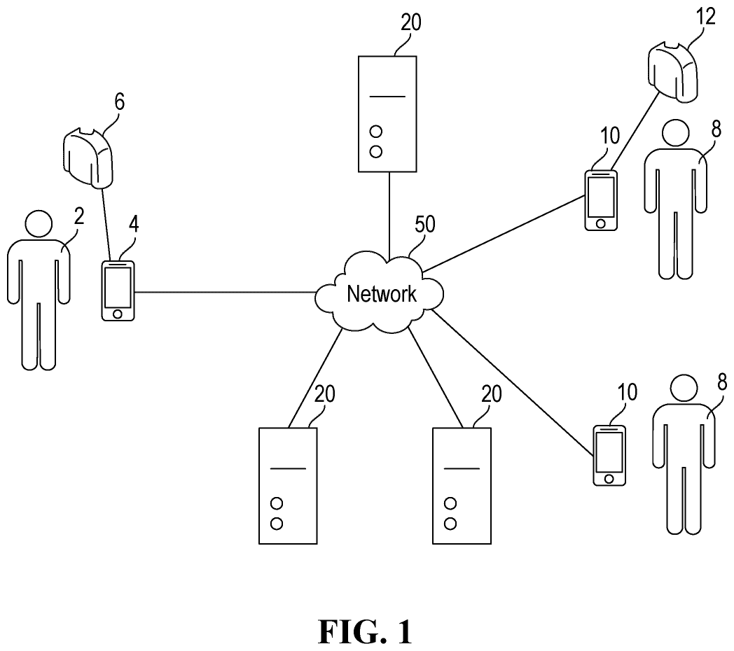

FIG. 1 illustrates a network environment that facilitates electronic communication enhanced with metadata, in accordance with an embodiment. As depicted, this network environment includes a communication network 50, network-interconnected servers 20, network-interconnected end-user computing devices 4, and network-interconnected end-user computing devices 10. As detailed herein, computing device 4 is operable by a user 2 to engage in electronic communication with one or more individuals 8, each operating a respective computing device 10, where such electronic communication is enhanced with metadata. In some embodiments, such electronic communication includes visual indicators of metadata.

In the depicted embodiment, when user 2 is engaged in electronic communication with a given individual 8, device 4 is adapted to enhance the electronic communication by presenting user 2 with a visual representation of metadata reflective of at least one state of the given individual 8. For example, the state may be a location state, a social connectedness state, a biomechanics state, a mood state, or a health and wellness state of the individual 8. The metadata is received from a plurality of disparate sources, including any combination of one or more devices 10, one or more smart garments 12, and one or more servers 20, as detailed below.

As illustrated, computing device 4 is interconnected with other computing devices 10 and servers 20 through communication network 50. Network 50 may be the public Internet, but could also be a private intranet. So, network 50 could, for example, be an IPv4, IPv6, X.25, IPX compliant or similar network. Network 50 may include wired and wireless points of access, including wireless access points, and bridges to other communications networks, such as GSM/GPRS/3G/LTE or similar wireless networks. When network 50 is a public network such as the public Internet, it may be secured as a virtual private network.

Each server 20 may be a cloud-based server or other remote server that includes an electronic datastore of metadata relating to a plurality of individuals 8. Such metadata may be received at server 20 from device 10 or other devices used by or are proximate to individuals 8, such as smartwatches, fitness tracking devices, environmental sensors, or the like. In some embodiments, server 20 provides at least some of the metadata stored in its datastore to devices such as computing devices 4, e.g., by way of an application programming interface (API).

Computing device 4 includes software (e.g., an enhanced communication application), which when executed, adapts device 4 to facilitate electronic communication enhanced with metadata. In the depicted embodiment, computing device 4 is a smartphone device such as an iPhone smartphone, an Android-based smartphone, or the like. In other embodiments, computing device 4 may be a personal computer, a laptop, a personal data assistant, a tablet computer, a video display terminal, a gaming console, or any other computing device capable of being adapted for electronic communication in manners described herein.

Similarly, each computing device 10 may be a smartphone or any other computing device capable of being adapted for electronic communication in manners described herein.

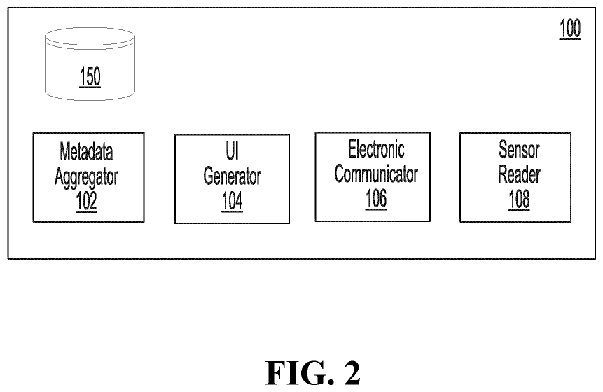

FIG. 2 is a schematic diagram of an enhanced communication application 100, in accordance with an embodiment, which may be executed at computing device 4.

In the depicted embodiment, enhanced communication application 100 includes metadata aggregator 102, user interface generator 104, electronic communicator 106, and sensor reader 108.

Metadata aggregator 102 receives metadata for individuals 8 with whom user 2 is engaging in electronic communication. This metadata may be received by way of network 50. This metadata may be received from a plurality of disparate sources.

The disparate sources may include, for example, sensors located on a device 10, an application executing on devices 10, a sensor located on a smart garment 12 worn by an individual 8, and a data repository located at a server 20. Metadata may be received directly from these disparate sources, e.g., by way of a data transmission through network 50. Metadata may also be received indirectly from these disparate sources. For example, metadata obtained at smart garment 12 may be first sent to device 10, which sends the metadata to server 20, which then in turn sends the metadata to computing device 4.

Some of the metadata may reflect a location state of an individual 8. The location state may, for example, include an exact location, a geofenced location, a semantic description of the location, e.g., whether the individual 8 is at work or at home or another semantically-identified location, or the like. The location state may also, for example, include certain travel data for the individual 8 such as distance travelled (e.g., in a pre-defined time period such as one day), time travelled, mode of transportation, or the like. The location state may also, for example, include environmental data such as air quality, noise levels, ambient temperatures, weather events, etc., at the location of the individual 8.

Some of the metadata may reflect a health or wellness state of an individual 8. For example, the health or wellness state may include an ECG sensor reading, an EEG sensor reading, a heart rate variability (HRV) reading (e.g., pulse rate, blood pressure), a mood or stress level state (as inferred from an HRV reading), a body temperature reading, biometrics such as MET Mins or energy expenditure, a sweat sensor reading, an incontinence sensor reading, an SpO2 sensor reading, an EMG sensor reading, whether the person has indicated their state to be happy, calm, sad, worried or annoyed, or the like. The metadata can also include states derived or inferred from the foregoing such as, for example, heart events (e.g., an atrial fibrillation event, frequency of such an event, time and summary), sleep stages, EEG waveform, resting and elevated heart rate, min/max/mean/standard deviation of heart rate or blood pressure (systolic or diastolic readings), stress % of day per mood type, number of MET Mins and trends, calories (kcal), hydration levels, electrolyte levels, glucose levels, biofeedback and urine analysis, % of O2, muscle(s) activated by activity, or the like.

Some of the metadata may reflect a biomechanics state of an individual 8, such as a posture state or an activity state. Posture state may include, for example, sitting posture or standing posture. Activity state may include, for example, resting state, sleeping state, walking state, running state, stair climbing state, or the like. The metadata can also include states derived or inferred from the foregoing such as, for example, percentage or minutes per day of each activity state, total number of steps climbed, total steps or distance walked/ran, or the like.

Some of the metadata may reflect a fitness state of an individual 8. For example, the metadata may include fitness session information such as type of exercise performed during a fitness session (dumbbell curl, bodyweight squat, running, rowing, swimming, etc.), number of consecutive repetitions of an exercise performed (reps), length of time performing an exercise, and number of sets of an exercise performed. In some embodiments, the metadata can include the length and intensity of exercises sessions (e.g., cardiovascular sessions). In some embodiments some of the metadata may be inferred. In some embodiments some of this metadata may be manually input.

In some embodiments, an activity state may include recovery states that can track the biomechanics state of an individual 8 as they transition from an active state such as a running state or stair climbing state to a passive state such as a resting state or a sleeping state. The metadata can include the time that individual 8 remains in a recovery state. The metadata can also include comparisons of current recovery state metadata to historic recovery state metadata.

In some embodiments, metadata can include historic fitness state information of an individual. For example, in some embodiments, the metadata may include data about a current fitness session performed on a current day and also include comparative data to analogous historic fitness session performance (e.g., it compares running sessions to historic running sessions). This can include a comparison of the current fitness session performance to average analogous performance (all time or rolling average), personal best performance, and the like. Some embodiments can also include biomechanics state comparisons to show fitness improvements or developments of individual 8 in response to the same type of fitness session at different times.

Some of the metadata may reflect a social connectedness state of an individual 8 such as, for example, who is within a social network group of individual 8, who is physically proximate individual 8, and who is connected and communicating with individual 8 online, or the like. In one example, such metadata may assist user 2 in identifying when an elderly individual 8 is isolated (e.g., physically and/or electronically through absence of online communication). In one example, such metadata may assist user 2 in identifying who to contact to assist an individual 8 (e.g., when a slip or fall has been detected) based on who is physically proximate that individual 8.

Some of the metadata may reflect whether an individual 8 is wearing a particular smart garment, e.g., as detected by sensors on that smart garment. Some of the metadata may reflect which sensor types are available on a particular smart garment. For example, different types of metadata may be available depending on the available sensor types. Some of the metadata may reflect placement of sensors on a particular smart garment (e.g., on the arm, on the chest, etc.).

Metadata aggregator 102 may receive metadata in disparate formats and may include various converters for converting data from these disparate formats, e.g., into one or more standard formats defined by respective schemas. Such schemas may include for example an XML schema.

Metadata aggregator 102 may process received metadata to generate further metadata derived or inferred from received metadata.

Metadata aggregator 102 may process received metadata to generate insights and recommendations, which may be presented alongside metadata. Such insights and recommendations may, for example, relate a state of one or more individuals 8.

Metadata received or generated at metadata aggregator 102 (including insights and recommendations) may be stored in electronic datastore 150. Datastore 150 may, for example, include one or more databases. Such databases may include a conventional relational database such as a MySQL™, Microsoft™ SQL, Oracle™ database, or another type of database such as, for example, an objected-oriented database or a NoSQL database. As such, electronic datastore 150 may include a conventional database engine for accessing database, e.g., using queries formulated using a conventional query language such as SQL, OQL, or the like.

User interface generator 104 generates a user interface for electronic communication with one or more individuals 8. Generating this user interface includes generating a visual representation of the metadata received or generated by metadata aggregator 102, with the visual representation including a plurality of visual indicator of various states of an individual 8, as reflected by the metadata.

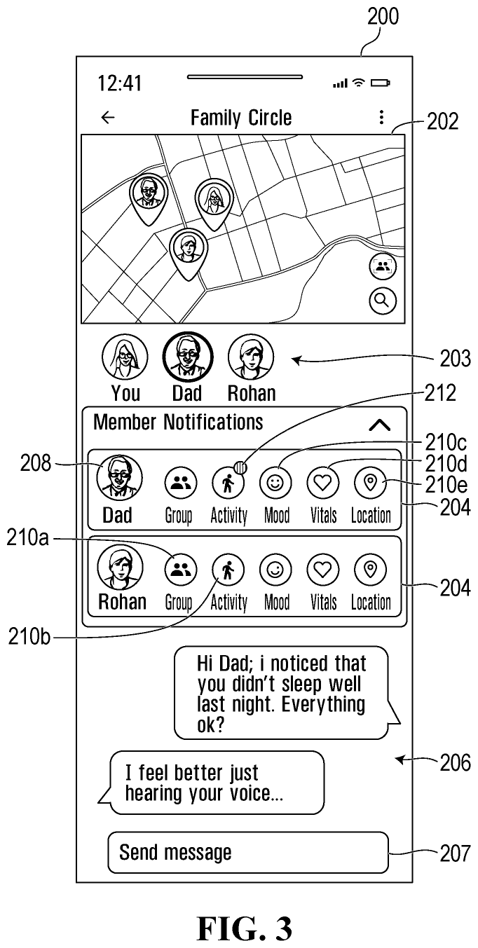

FIG. 3 depicts an example user interface (UI) 200 (generated by user interface generator 104), in accordance with an embodiment.

As depicted in FIG. 3, a user 2 is engaged in electronic communication (e.g., an instant messaging group chat) with two individuals 8 (i.e., Dad and Rohan), by way of UI 200. In other examples, a user 2 may be engaged in electronic communication with a single individual by way of UI 200. In other examples, a user 2 may be engaged in electronic communication with more than two individuals (e.g., a social network group, a family group, etc.) by way of UI 200.

As depicted, UI 200 includes an electronic map 202 with indicators of the respective locations of participants in the electronic communication. These indicators are updated based on received location metadata. UI 200 also displays a list 203 of the communication participants. UI 200 also includes, for each individual 8, a visual representation 204 of the metadata received for that individual 8. UI 200 also includes a chat portion 206 that has a chat history and a text entry box 207 that allows user 2 to enter new text messages.

As depicted, visual representation 204 includes a visual representation 208 of an individual 8, and a plurality of icons, each graphically representing a state of the individual 8. As depicted, these icons include, an icon 210a representing a social connectedness state, an icon 210b representing a biomechanics state, an icon 210c representing a mood state, an icon 210d representing a health and wellness state, and an icon 210e representing a location state. Icons 210a, 210b, 210c, 210d and 210e may be individually referred to as an icon 210 and collectively referred to as icons 210 herein. In some embodiments, visual representation 208 may be generated to include at least one of text, symbols, images, graphics, or the like. In some embodiments, icons 210 may be replaced by another type of graphic emblem, symbol, or simply with text.

Visual representation 208 may be static or dynamic, e.g., change in response to a changed state of an individual 8 or to the passage of time. In the depicted embodiment, visual representation 208 is a static image of individual 8. In other embodiments, visual representation 208 may include a video (e.g., a live video stream or pre-recorded video data) of individual 8. In other embodiments, visual representation 208 may include an animated avatar of individual 8. In some of these embodiments, the avatar may be animated to reflect received metadata. In one example, the avatar's face may be animated to reflect a mood state of individual 8. In another example, the avatar's body may be animated to reflect a posture state of individual 8. In another example, the avatar's body may be animated to reflect an activity state of the individual 8 (e.g., sleeping, walking, running, etc.). In some embodiments, a change in color of an aspect of visual representation 208 or playback of particular audio data may be used to reflect received metadata. In one example, the particular audio data may, for example, include a chime, melody, or other sound or music data. In another example, the particular audio data, may for example, include a voice greeting or other voice recording or voice samples of the individual 8.

In some embodiments, the form of visual representation 208 may depend on a user preference setting selected by individual 8. In one example, an individual 8 may select to share a static image when they are away from home, and to share a real-time video feed when they are at home. In some embodiments, the form of visual representation 208 may depend on a parameter specifying the closeness of a relationship between user 2 and an individual 8. In one example, an individual 8 may select to share a real-time video feed with close friends and family members, and select to share a static image with others.

In some embodiments, individual 8 can select to remove the visual representation 208 altogether.

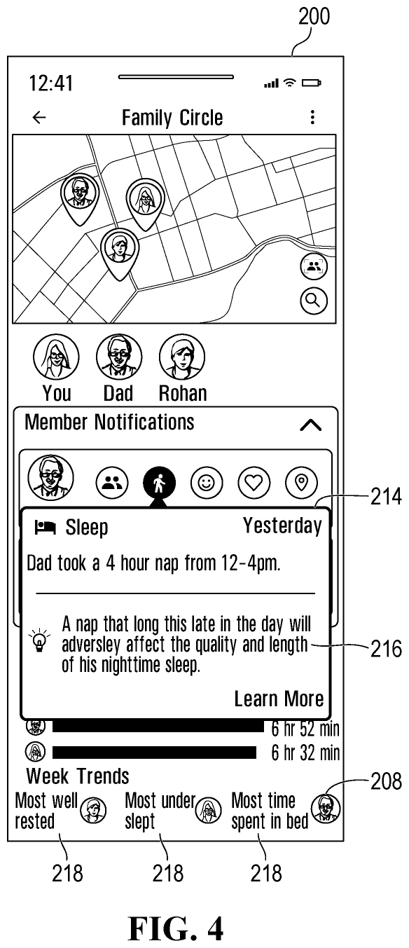

Referring now to FIG. 4, each icon 210 can be activated (e.g., by a touch or a click) to reveal an information panel 214 that presents further information about the represented state. For example, as shown, activating the icon 210 representing the biomechanics state of an individual 8 (in this case “Dad”) reveals an information panel 214 that presents information about Dad's sleep including recommendations and insights 216 that are generated by metadata aggregator 102.

In some embodiments, a recommendation or insight may be generated in the form of a notice (e.g., textual, graphical, audio) or a tip to trigger action or learning on the part of user 2. In one example, a recommendation or insight may provide user 2 with information that an individual 8 needs particular assistance. In another example, a recommendation or insight may provide user 2 with information that an individual 8 has reached a particular goal, and, for example, should be acknowledged or praised.

Insights displayed via UI 200 may also include insights 218 relating to state trends for a particular individual 8 or a group of individuals 8. In one example, insights in relation to sleep may include indicators of who is the most well rested, who is the most under slept, and who spent the most time in bed, etc. In other examples, insights relating to other state trends (e.g., mood, location, biometrics, etc.) may be shown.

Each insight relating to a specific individual may be shown alongside a visual representation 208 of that individual.

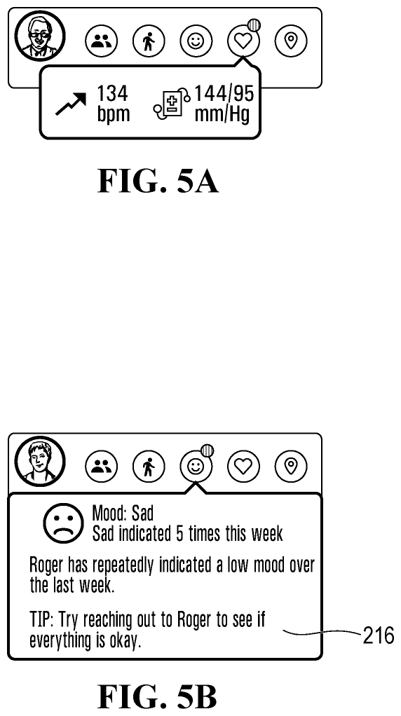

FIG. 5A shows an example information panel 214 presenting information about a health and wellness state of an individual 8. As depicted, panel 214 includes information regarding heart rate and blood pressure of individual 8. FIG. 5B shows an example information panel 214 presenting information about a mood state of an individual 8. As depicted, panel 214 shows that the current mood is “Sad”, and provides a generated recommendation 216 that user 2 should reach out to individual 8.

Referring again to FIG. 3, a notification indicator 212 may be presented in visual connection to an icon 210 notification indicator indicating that there is a metadata update for the state represented by that icon 210. A notification indicator 212 may be shown, for example, when new metadata has been received or a new insight or recommendation has been generated at metadata aggregator 102. The colour of notification indicator 212 may indicate the type of alert. For example, in one embodiment, a notification indicator 212 indicates a metadata update while a notification indicator 212 indicates an urgent metadata update. In one example, a notification indicator 212 may indicate an urgent metadata update, when for example, the metadata indicates a slip and fall condition has been detected or predicted for an individual 8. In some embodiments, notification indicator 212 may also include one or more symbols or other visual indicia representative of a type of alert.

While user 2 is engaged in electronic communication with one or more individuals 8, user interface generator 104 updates portions of user interface 200, e.g., including map 202 and visual representation 204, from time to time, e.g., periodically or in response to new metadata being received or generated at metadata aggregator 202.

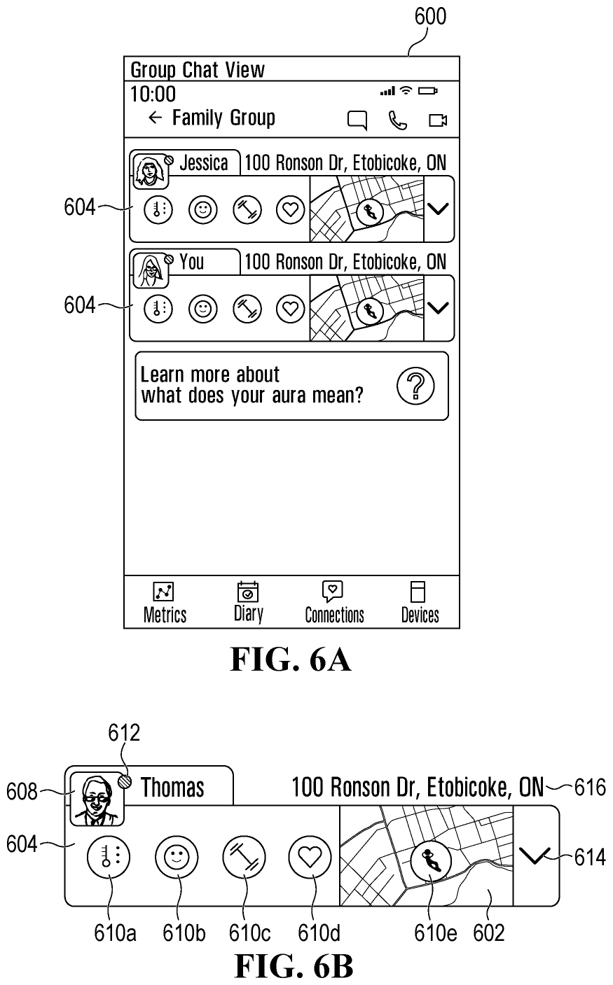

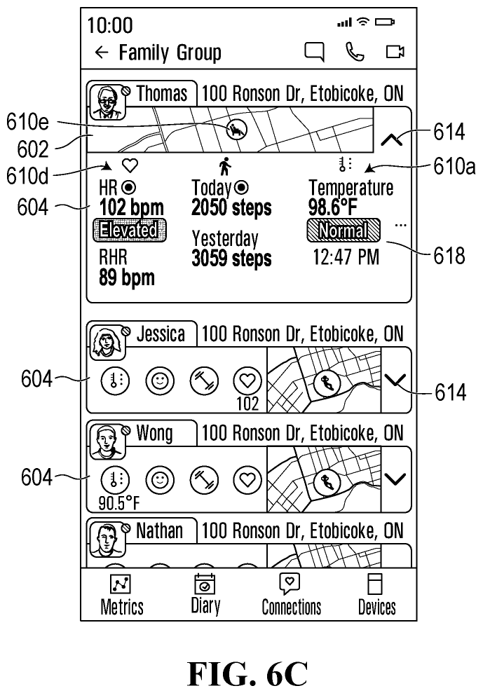

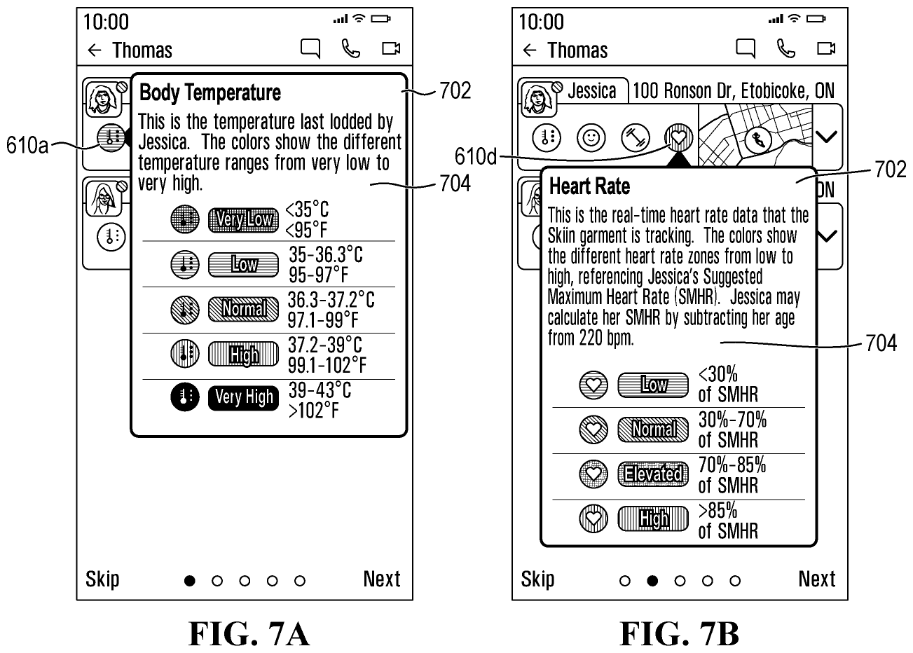

FIG. 6A depicts an example UI 600 (generated by user interface generator 104), in accordance with another embodiment.

UI 600 may, for example, show visual representations of metadata for a plurality of individuals 8, with whom user 2 may engage in electronic communication. The plurality of individuals 8 may represent a pre-defined group corresponding to, for example, a group of family members, a group of co-workers, a group of patients, or the like. Conveniently, UI 600 provides a visually compact, yet information dense, summary of metadata for the plurality of individuals 8. This facilitates efficient data exchange during data communications.

As depicted, UI 600 includes, for each individual 8, a visual representation 604 of the metadata received for that individual 8. As shown in FIG. 6B, visual representation 604 includes a visual representation 608 of an individual 8, and a plurality of icons, each graphically representing a state of the individual 8. As depicted, these icons include an icon 610a representing a body temperature state, an icon 610b representing a mood state, an icon 610c representing a fitness state, an icon 610d representing a heart rate state, and an icon 610e representing a biomechanics and location state. Icons 610a, 610b, 610c, 610d and 610e may be individually referred to as an icon 610 and collectively referred to as icons 610 herein.

In some embodiments, icons 610 may be replaced by another type of graphic emblem, symbol, or simply with text. A visual representation 608 may be substantially similar to visual representation 208 described above. In some embodiments, visual representation 608 can be accompanied by a status indicator 612. Status indicator 612, can show the current availability state of individual 8. Availability state can indicate the in-app availability of individual 8. Availability states can include “Available” meaning individual 8 is using the enhanced communication application 100, “Away” meaning individual 8 is not using the enhanced communication application 100, and “Offline” meaning device 10 is not active.

In some embodiments, the icons 610 can be accompanied by other visual indicators to convey more metadata. For example, as depicted, state icon 610 corresponding to the biomechanics and location state of individual 8, can be superimposed on electronic map 602 representing the location of individual 8 (e.g., as detected by a GPS sensor at a device 10). Additionally, visual representation 604 can include an address 616 representing the location of individual 8. These indicators are updated based on received location metadata.

As depicted in FIG. 6A, UI 600 can include electronic map 602 for each individual 8 within their corresponding visual representation 604 rather than one large electronic map that depicts all individuals as illustrated by electronic map 202 in FIG. 3. In some embodiments, user 2 can optionally choose between the single electronic map display illustrated in FIG. 3 and the multi electronic map display as illustrated in FIG. 6A.

Visual representation 604 can also include an expanded view button 614 that user 2 can activate to expand the amount of metadata detail conveyed to user 2 through visual representation 604, as shown for example in FIG. 6C.

FIG. 6C depicts UI 600 reconfigured to expand the amount of metadata detail conveyed, in accordance with an embodiment.

As noted above, for each visual representation 604 of individual 8, there is an associated expanded view button 614 that user 2 can activate (e.g., by a touch or a click) to increase or decrease the amount of metadata detail conveyed to user 2 through visual representation 604. When button 614 is activated to increase the amount of metadata detail, UI 600 is reconfigured to display more metadata to user 2. Such reconfiguration can include, for example, repositioning and/or resizing icons 610 and electronic map 602 to display more of the metadata to user 2. Such reconfiguration can also include, for example, the detail level in visual representation 604, said detail level defining the composition of visual representation 604. For example, as depicted in FIG. 6C, electronic map 602 and icon 610e, representing the biomechanics and location state, have moved to a top portion of visual display 604. Other icons 610 representing the other states, are now displayed below electronic map 602.

State information 618 has also been added to visual representation 604. State information 618 can include measured data and current state of the state associated with at least one icon 610. In some embodiments, state information 618 can include historic metadata (averages, yesterday's data, previous baselines, etc.) for comparison by user 2. In some embodiments, state information 618 can categorize some pieces of metadata relative to expected metadata for individual 8 (e.g., low, normal, elevated, high, etc.).

In some embodiments, state information 618 can be colour coded. Colour coding can be used to visually distinguish state information 618 between different states. For example, green can be used to denote state information that is normal or typical for individual 8 while red can be used to denote state information that is deviant or atypical for individual 8. User 2 can check the metadata associated with at least one icon 610 by referring to the colour of state information 618 rather than referring to a precise metric of state information 618.

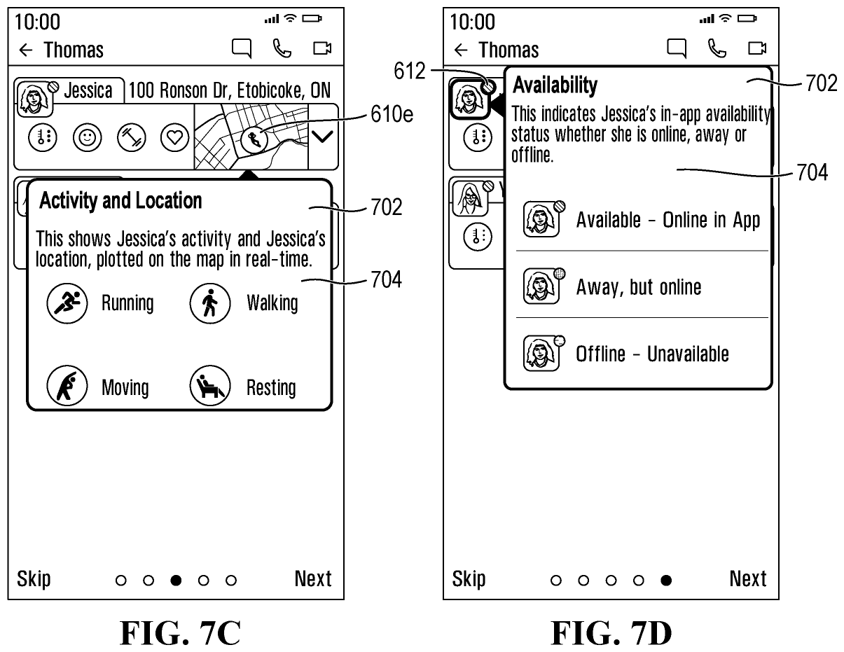

User 2 is able to see information about individual 8 at a glance while expanded view button 614 is not engaged. This can allow user 2 to see all visual representations 604 corresponding to each of individuals 8. Expanded view button 614 can be activated by user 2 when they want to assess the information relating to one of individuals 8 in greater detail. Expanded view button 614 can be re-activated by user 2 to decrease the amount of displayed information, e.g., to cause UI 600 to be reconfigured to the form shown in FIG. 6A. FIGS. 7A, 7B, 7C, and 7D each show an example information panel 702 that is displayed when a user 2 activates an icon 610 or a status indicator 612, in accordance with an embodiment. User 2 can consult information panel 702 to receive more information such as a brief description 704 of the corresponding state and an explanation regarding the visual representation of the corresponding icon 610 or indicator 612.

FIG. 7A illustrates information panel 702 that corresponds to body temperature state, presented upon activation of icon 610a. FIG. 7B illustrates information panel 702 that corresponds to heart rate state, presented upon activation of icon 610d. FIG. 7C illustrates information panel 702 that corresponds to activity and location state, presented upon activation of icon 610e. FIG. 7D illustrates information panel 702 that corresponds to availability state, presented upon activation of indicator 612.

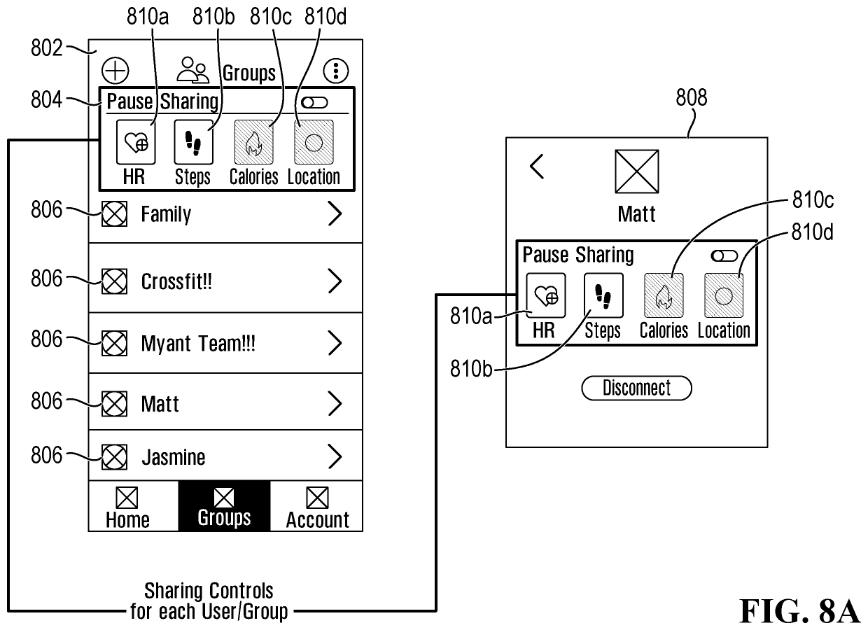

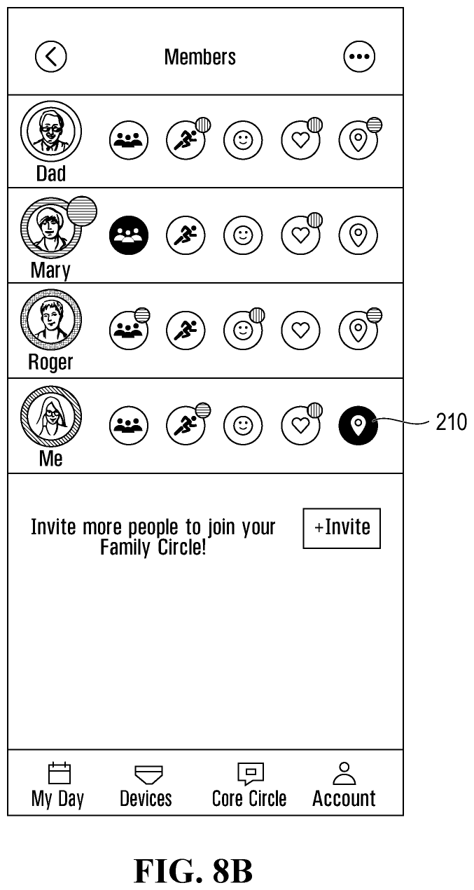

FIG. 8A illustrates sharing control panel 802. Sharing control panel 802 allows a user to toggle the state data or metadata shared with other users (e.g., shared by user 2 and individuals 8, or shared by an individual 8 with user 2, or shared by an individual 8 with other individuals 8, or the like). For example, pause icon 810a can activate and deactivate sharing heart rate state data; pause icon 810b can activate and deactivate sharing steps state data; pause icon 810c can activate and deactivate sharing calories state data; pause icon 810d can activate and deactivate sharing location state data. Pause icons 810a, 810b, 810c, and 810d may be individually referred to as a pause icon 810 and collectively referred to as pause icons 810 herein. In some embodiments, icons 810 may be replaced by another type of graphic emblem, symbol, or simply with text. When a pause icon is active it will share the state data or metadata associated with that pause icon with some individuals 8. When a pause icon is deactivated, then the state data or metadata associated with that pause icon will not be shared with some individuals 8.

In some embodiments, by activating a particular pause icon 810 from the global sharing control pane 804, a user can alter their sharing control settings with all other users. Alternatively, in some embodiments, a user can select a group or individual 806 to determine precisely which other users will receive certain types of state data or metadata. By activating group or individual 806, the display will reconfigure to show group or individual sharing control pane 808 associated with group or individual 806. When a user activates or deactivates pause icons 810 through group or individual sharing control pane 808, it will only modify the sharing controls for that individual or individuals in that group. In this way, a user can control with whom metadata is shared.

In some embodiments, the appearance of a pause icon 810 depends on whether sharing of the associated type of state data is presently activated or deactivated. Referring to FIG. 8A as one example, pause icons 810a and 810b are coloured showing that they are presently active and pause icons 810c and 810d have been greyed out to show that they are deactivated. Other alterations can include overlaying the pause icon with an ‘X’ when deactivated.

In some embodiments, activation or deactivation of pause icons 810 will persist when the enhanced communication application 100 and/or device 4 has been shut down or restarted.

As depicted in FIG. 8B, an icon 210 (or icon 610) may be darkened, to indicate that an individual 8 has elected not to share state information represented by that category. Individual 8 can make such elections through their sharing control panel 802.

Electronic communicator 106 sends communication data reflective of electronic communication to one or more of devices 10 operated by individuals 8 with whom user 2 is engaged in electronic communication. Electronic communicator 106 also receives communication data reflective of electronic communication from one or more of devices 10. In the depicted embodiment, this communication data may include textual data, e.g., entered by user 2 into the text entry box of chat portion 206. In other embodiments, communication data may include audio data, video data, or the like.

Sensor reader 108 reads from various sensors of device 4 (e.g., GPS sensor) and devices connected thereto (e.g., by WiFi, Bluetooth, USB, etc.), including for example various sensors of a smart garment 6 worn by user 2. Such sensor data may be transmitted to a server 20 for storage in a metadata repository. For example, such data may be retrieved by a device 10 that executes enhanced communication application 100 to process and display metadata in manners described herein. Such metadata, for example, be displayed at a device 10 to an individual 8 who is engaged in electronic communication with user 2. In some embodiments, sensor data may be transmitted directly to a device 10.

As shown in FIG. 8A, enhanced communication application 100 provides a configuration interface allowing user 2 to control which types of metadata to share automatically with particular individuals 8, or with particular groups of individuals 8.

In some embodiments, electronic communicator 106 may send metadata of user 2 to a device 10, for display to individual 8. This metadata may reflect any of the location, social connectedness, biomechanics, mood, and health and wellness states described herein. In some embodiments, this metadata may be sent in the form of a text message. In some embodiments, this metadata may be sent in the form of a digital image. In some embodiments, this metadata may be sent in the form of a virtual card (vcard).

Each of metadata aggregator 102, user interface generator 104, electronic communicator 106, and sensor reader 108 may be implemented using conventional programming languages such as Java, J #, C, C++, C #, Perl, Visual Basic, Ruby, Scala, etc. These components of application 100 may be in the form of one or more executable programs, scripts, routines, statically/dynamically linkable libraries, or the like.

In the embodiment depicted in FIG. 3, enhanced communication application 100 is adapted for electronic communication in the form of instant messaging. In other embodiments, enhanced communication application 100 is adapted for electronic communication including one or more of electronic mail, SMS, or other text-based communication. In other embodiments, enhanced communication application 100 is adapted for electronic communication including one or more of audio communication, video communication, AR communication, or VR communication. In some cases, electronic communication is live communication which may be one-way, two-way, or multi-way (e.g., more than 2 participants) communication. In some cases, electronic communication is pre-recorded communication (e.g., a pre-recorded video message, a voicemail, or the like).

Conveniently, use of computing device 4 may provide enhanced electronic communication between user 2 and one or more individuals 8. In one example, user 2 may electronically communicate a joke to an individual 8. User 2 may then receive a metadata update reflecting a change of mood of individual 8 from Sad to Happy, providing feedback to user 2. Changes in mood can also be determined from the metadata, e.g., as an insight generated by metadata aggregator, or may be reported by individual 8. In another example, user 2 may be a fitness instructor who electronically communicates instructions to a group of individuals 8 attending a fitness class. User 2 may receive metadata updates reflecting one or more of change of posture, change of activity (e.g., from walking to running), or change of heart rate, thereby providing feedback to user 2. As will be appreciated, enhanced electronic communication between user 2 and one or more individuals 8 may allow even more information to be conveyed than is possible in face-to-face communication, such extra information including, for example, various health and wellness sensor data.

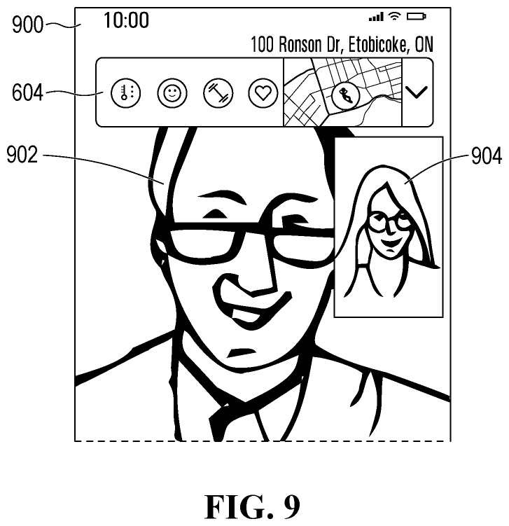

FIG. 9 illustrates an embodiment of enhanced communication application 100 wherein user 2 is communicating with individual 8 using video communication (e.g., a Zoom™ or Skype™ video conference). FIG. 9 shows a UI 900, e.g., generated by UI generator 104. UI 900 includes a video window 902 for displaying an incoming video of individual 8, and a video window 904 for displaying an outgoing video of user 2. This video communication is enhanced by metadata regarding the state of individual 8, as presented by way of metadata visual representation 604. In this way, metadata regarding the state of individual 8 is conveyed to individual 2 during electronic communication therebetween.

Enhanced communication application 100 can be used by user 2 in order to gain more information corresponding to individual 8 reflective of at least one of location, social connectedness, biomechanics, mood, and health and wellness states. In one example, user 2 can determine whether individual 8 has a low temperature based on communication with individual 8 and based on the visual representation of metadata 604, which can be configured to display the body temperature state of individual 8. In another example, user 2 can quickly ascertain the location of individual 8 by referring to visual representation 604.

In some situations, a visual representation 204 or visual representation 604 depicting metadata for an individual 8 may be referred to as the “aura” for that individual 8.

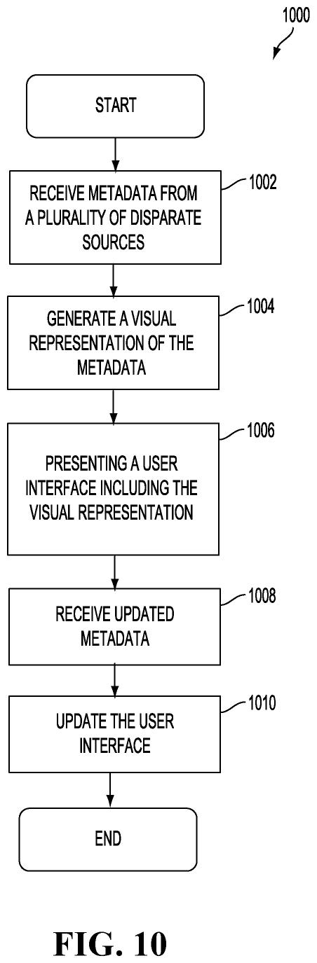

The operation of enhanced communication application 100 is further described with reference to the flowchart depicted in FIG. 10.

As depicted, enhanced communication application 100, executing at a computing device 4 operated by a user 2, performs the example operations depicted at blocks 1000 and onward, in accordance with an embodiment.

At block 1002, enhanced communication application 100 receives metadata from a plurality of disparate sources. The metadata is reflective of at least one of location, social connectedness, biomechanics, mood, and health and wellness states of an individual 8 with whom a user 2 is engaging in electronic communication. In some embodiments, although the metadata is from a plurality of disparate sources (i.e., originating from a plurality of disparate sources), the transmission of metadata received at device 4 is from a single device 10 operated by the individual 8.

At block 1004, enhanced communication application 100 generates a visual representation of the metadata. The visual representation includes a plurality of visual indicators of the aforementioned states. In some embodiments, this visual representation may be visual representation 204 or visual representation 604.

At block 1006, enhanced communication application 100 presents a user interface for electronic communication with the individual 8. The user interface includes the generated visual representation.

Thereafter, while user 2 is engaging in electronic communication with the individual 8, at block 1006, enhanced communication application 100 receives updated metadata from at least one of the disparate sources, and at block 1008, updates the user interface to reflect the updated metadata. In this way, the user interface is updated repeatedly to display most recently received metadata. In some situations, the user interface may be updated every few seconds. In some situations, the user interface may be updated in near real-time. As will be appreciated, some types of metadata may be updated more or less frequently than other types of metadata. For example, metadata relating to an individual's heart rate may be updated frequently (e.g., once per second), while metadata relating to sleep patterns may be updated less frequently (e.g., once per day).

It should be understood that steps of one or more of the blocks depicted in FIG. 10 may be performed in a different sequence or in an interleaved or iterative manner. Further, variations of the steps, omission or substitution of various steps, or additional steps may be considered.

Although embodiments of enhanced communication application 100 has been described herein from the perspective of user 2, one or more individuals 8 may also be operating enhanced communication application 100. Thus, the transmission of metadata during electronic communication between a user 2 and one or more individuals 8 may be bidirectional. This may be appropriate, for example, when electronic communication is conducted among a group of friends or peers. In such situations, a computing device 10 may operate in manners as described for a computing device 4.

In some situations, metadata is transmitted only from an individual 8 to a user 2. This may be appropriate, for example, when user 2 is a care provider that provides care to that individual 8. In such cases, the individual 8 may be operating a configuration of enhanced communication application 100 that collects metadata about the individual 8 but does not display metadata about user 2.

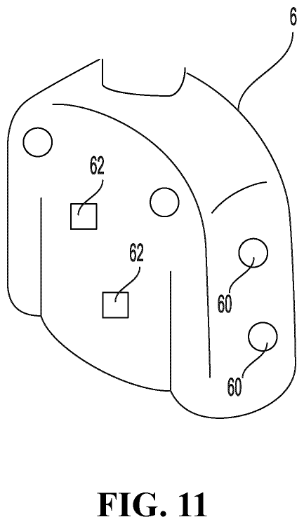

FIG. 11 shows smart garment 6, in accordance with an embodiment. As depicted, smart garment 6 includes one or more sensors 60 for sensing a state of an individual 8.

As depicted, smart garment 6 is adapted to be disposed over an upper body section of an individual, such as a t-shirt, a long-sleeved shirt, a blouse, a dress, among others. In another embodiment, smart garment 6 may be adapted to be disposed over a lower body section of an individual, such as a pair of pants, shorts, underwear, socks, among others. In another embodiment, smart garment 6 may be disposed over another body section of an individual such as a head or one or more of the extremities (e.g., a hand or foot). In another embodiment, smart garment 6 may be disposed over multiple body sections of an individual.

Sensors 60 may include various types of sensors suitable for sensing electrophysiological signals including Electromyogram (EMG), Electroencephalogram (EEG), Electrocardiogram (ECG), Electrooculogram (EOG), and Electrogastrogram (EGG) signals, or the like. Sensors 60 may also include various sensors suitable for sensing biomechanical feedback such as stretch sensors, pressure sensors, accelerometers, gyroscopes, magnetometer, inertial measurement units, or the like. Sensors 60 may also include sensors suitable sensing body temperature, blood pressure, pulse, etc. Sensors 60 may also include sensors suitable for sensing the presence of bodily fluids such as sweat, blood, urine, etc.

Smart garment 6 may optionally include one or more actuators 62. Actuator 62 may include various types of actuators suitable for applying current/voltage to user 2 for Functional Electrical Stimulation (FES), Transcranial Current Stimulation (TCS), Transcutaneous electrical nerve stimulation (TENS), High-Frequency Alternating Current Stimulation, and/or creating a tactile sensation. Actuators 62 may also include actuators suitable for providing temperature regulation (e.g., heaters to provide heating or coolers to provide cooling). Actuators 62 may also include actuators suitable dispensing medication, e.g., medication for providing localized pain relief, for promoting wound healing, etc. Actuators 62 may include actuators suitable for changing the permeability of the skin, e.g., through iontophoresis, which may be used in conjunction with actuators suitable for dispensing medication to facilitate transdermal delivery of the medication.

In some embodiments, enhanced communication application 100 may transmit a control signal to smart garment 6 to activate an actuator 62. This activation may be in response to receipt of electronic communication from a device 10.

Smart garment 12 may be substantially similar to smart garment 6.

In some embodiments, communication application 100 may transmit electronic communication to a computing device 10 for activating an actuator of a smart garment 12.

In the depicted embodiment, smart garment 6 is formed of a knitted textile. Smart garment 6 includes a plurality of conductive fibres interlaced with a plurality of non-conductive fibres. The conductive fibres define a plurality of signal paths suitable for delivering data and/or power to sensor 60 and actuators 62. In some embodiments, smart garment 6 may be formed of other textile forms and/or techniques such as weaving, knitting (warp, weft, etc.) or the like. In some embodiments, smart garment 6 includes any one of a knitted textile, a woven textile, a cut and sewn textile, a knitted fabric, a non-knitted fabric, in any combination and/or permutation thereof. Example structures and interlacing techniques of textiles formed by knitting and weaving are disclosed in U.S. patent application Ser. No. 15/267,818, entitled “Conductive Knit Patch”, the entire contents of which are herein incorporated by reference.

As used herein, “textile” refers to any material made or formed by manipulating natural or artificial fibres to interlace to create an organized network of fibres. Generally, textiles are formed using yarn, where yarn refers to a long continuous length of a plurality of fibres that have been interlocked (i.e., fitting into each other, as if twined together, or twisted together). Herein, the terms fibre and yarn are used interchangeably. Fibres or yarns can be manipulated to form a textile according to any method that provides an interlaced organized network of fibres, including but not limited to weaving, knitting, sew and cut, crocheting, knotting and felting.

Different sections of a textile can be integrally formed into a layer to utilize different structural properties of different types of fibres. For example, conductive fibres can be manipulated to form networks of conductive fibres and non-conductive fibres can be manipulated to form networks of non-conductive fibers. These networks of fibres can comprise different sections of a textile by integrating the networks of fibres into a layer of the textile. The networks of conductive fibres can form one or more conductive pathways that electrically connect with sensors 60 and actuators 62 of smart garment 6, for conveying data and/or power to and/or from these components.

In some embodiments, multiple layers of textile can also be stacked upon each other to provide a multi-layer textile.

As used herein, “interlace” refers to fibres (either artificial or natural) crossing over and/or under one another in an organized fashion, typically alternately over and under one another, in a layer. When interlaced, adjacent fibres touch each other at intersection points (e.g., points where one fibre crosses over or under another fibre). In one example, first fibres extending in a first direction can be interlaced with second fibres extending laterally or transverse to the fibres extending in the first connection. In another example, the second fibres can extend laterally at 90° from the first fibres when interlaced with the first fibres. Interlaced fibres extending in a sheet can be referred to as a network of fibres.

As used herein “integrated” or “integrally” refers to combining, coordinating or otherwise bringing together separate elements so as to provide a harmonious, consistent, interrelated whole. In the context of a textile, a textile can have various sections comprising networks of fibres with different structural properties. For example, a textile can have a section comprising a network of conductive fibres and a section comprising a network of non-conductive fibres. Two or more sections comprising networks of fibres are to be “integrated” together into a textile (or “integrally formed”) when at least one fibre of one network is interlaced with at least one fibre of the other network such that the two networks form a layer of the textile. Further, when integrated, two sections of a textile can also be described as being substantially inseparable from the textile. Here, “substantially inseparable” refers to the notion that separation of the sections of the textile from each other results in disassembly or destruction of the textile itself.

In some examples, conductive fabric (e.g., group of conductive fibres) can be knit along with (e.g., to be integral with) the base fabric (e.g., surface) in a layer. Such knitting may be performed using a circular knitting machine or a flat bed knitting machine, or the like, from a vendor such as Santoni or Stoll.

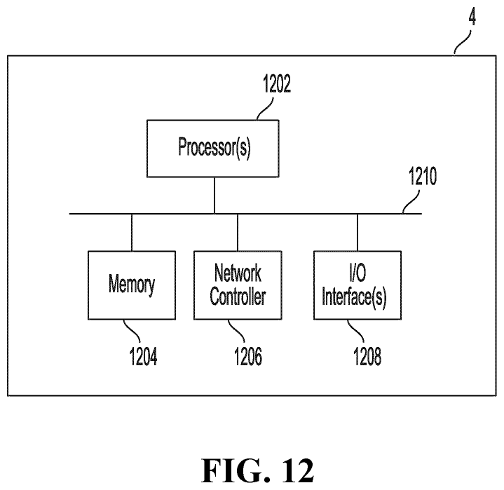

FIG. 12 is a schematic diagram of computing device 4, in accordance with an embodiment. As depicted, computing device 4 includes at least one processor 1202, memory 1204, at least one I/O interface 1208, and at least one network interface 1206, which may be interconnected by a bus 1210.

Each processor 1202 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 1204 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1208 enables computing device 4 to interconnect with one or more input devices, such as a keyboard, mouse, camera, touch screen and a microphone, or with one or more output devices such as a display screen and a speaker. An I/O interface 1208 enables computing device 4 to interconnect with smart garment 6 and receive input therefrom. When I/O interface 1208 is interconnected to a display screen, it may be referred to as a display interface.

Each network interface 1206 enables computing device 4 to communicate with other components, to exchange data with other components, to access and connect to network resources, to serve applications, and perform other computing applications by connecting to a network such as network 50 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

In some embodiments, a computing device 10 or a server 20 may have components and/or architecture as shown in FIG. 12 and described in relation thereto.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components.

Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps

As can be understood, the examples described above and illustrated are intended to be exemplary only. The scope is indicated by the appended claims.

1. A computing device for electronic communication enhanced with visual indicators of metadata, said device comprising:
a display interface;
at least one communication interface;
at least one memory storing processor-executable instructions; and
at least one processor in communication with said at least one memory, said at least one processor configured to execute said instructions to:
receive, by way of said at least one communication interface, metadata from a plurality of disparate sources, said metadata reflective of at least one of location, social connectedness, biomechanics, mood, and health and wellness states of an individual with whom a user of said computing device is engaging in electronic communication;
generate a visual representation of said metadata, said visual representation including a plurality of visual indicators of said states;
present, by way of said display interface, a user interface for electronic communication with said individual, said user interface including said generated visual representation of said metadata;
receive, by way of said at least one communication interface, updated metadata, from at least one of said disparate sources; and
update said user interface to reflect said updated metadata.

2. The computing device of claim 1, wherein said electronic communication comprises text-based communication.

3. The computing device of claim 1, wherein said electronic communication comprises at least one of electronic mail, instant messaging, or SMS.

4. The computing device of claim 1, wherein said electronic communication comprises at least one of audio communication, video communication, AR communication, or VR communication.

5. The computing device of claim 1, wherein said metadata is reflective of at least two of said location, social connectedness, biomechanics, mood, and health and wellness states of the individual.

6. The computing device of claim 5, wherein said metadata is reflective of at least three of said location, social connectedness, biomechanics, mood, and health and wellness states of the individual.

7. The computing device of claim 1, wherein said visual representation includes a visual representation of the individual.

8. The computing device of claim 1, wherein said visual representation includes a static visual representation of the individual.

9. The computing device of claim 1, wherein said visual representation includes a dynamic visual representation of the individual.

10. The computing device of claim 9, wherein said visual representation of the individual comprises an animated avatar of the individual.

11. The computing device of claim 10, wherein said animated avatar is animated to reflect said updated metadata.

12. The computing device of claim 9, wherein said visual representation of the individual comprises a video of the individual.

13. The computing device of claim 12, wherein said video comprises live video data.

14. The computing device of claim 12, wherein said video comprises a pre-recorded video data.

15. The computing device of claim 8, where said visual representation of the individual comprises audio data of the individual.

16. The computing device of claim 1, wherein the at least one processor is configured to execute said instructions to:
change, upon an interaction by the user, a detail level of the visual representation of the metadata.

17. A computer-implemented method for electronic communication enhanced with visual indicators of metadata, said method comprising:
at an electronic device, receiving metadata from a plurality of disparate sources, said metadata reflective of at least one of location, social connectedness, biomechanics, mood, and health and wellness states of an individual with whom a user of said computing device is engaging in electronic communication;
generating a visual representation of said metadata, said visual representation including a plurality of visual indicators of said states;
presenting a user interface for electronic communication with the individual, said user interface including said visual representation of said metadata; and
while the user is engaging in electronic communication with the individual:
receiving updated metadata from at least one of the disparate sources; and
updating said user interface to reflect the updated metadata.

18. The computer-implemented method of claim 17, further comprising sending communication data reflective of the electronic communication to the individual.

19. The computer-implemented method of claim 18, wherein the communication data comprises at least one of text data, audio data, video data, AR data, or VR data.

20. The computer-implemented method of claim 17, further comprising receiving communication data reflective of the electronic communication from the individual.

21. The computer-implemented method of claim 17, further comprising changing a detail level of the visual representation of the metadata, upon an interaction by the user.

22. A non-transitory computer-readable medium having stored thereon machine interpretable instructions which, when executed by a processor, cause the processor to perform a computer-implemented method for electronic communication enhanced with visual indicators of metadata, said method comprising:
at an electronic device, receiving metadata from a plurality of disparate sources, said metadata reflective of at least one of location, social connectedness, biomechanics, mood, and health and wellness states of an individual with whom a user of said computing device is engaging in electronic communication;
generating a visual representation of said metadata, said visual representation including a plurality of visual indicators of said states;
presenting a user interface for electronic communication with the individual, said user interface including said visual representation of said metadata; and
while the user is engaging in electronic communication with the individual:
receiving updated metadata from at least one of the disparate sources; and
updating said user interface to reflect the updated metadata.
